(19) United States
(12) Patent Application Publication
(10) Pub. No.: US 2003/0101182 A1
(43) Pub. Date: May 29, 2003

(54) Method and system for smart search engine and other applications

(76) Inventors: Omri Govrin, Eshhar (IL); Eri Moshe Govrin, Jerusalem (IL)

Correspondence Address: KATTEN MUCHIN ZAVIS ROSENMAN, 575 MADISON AVENUE, NEW YORK, NY, 10022-2585, US

(21) Appl. No.: 10/197,374

(22) Filed: Jul. 17, 2002

Related U.S. Application Data
(60) Provisional application No. 60/306,353, filed on Jul. 18, 2001.

(51) Int. Cl. G06F 7/00

(52) U.S. Cl. 707/7

(57) ABSTRACT

The present invention provides a new method for indexing a given text objects, using text parsing module and words indexing databases.

According to this method each word is assigned a first index code according to words meaning, a second index code according to each word syntax category and a third index code according to word syntactical role. The words indices are arranged according to hierarchical order based on syntactical relations between the text words. At the last stage, differentiating symbols, which represent indices hierarchical order, are assigned between adjacent words indices.

The indexing process may be implemented as automatic computerized program or as wizard application enabling human intervention in the indexing process.

The indexing method can be utilized for enabling text search utilities based on matching between The query indices and source text indices.

### 1. THE SCOPE OF THE INVENTION

The present invention relates to computerized, automatic organization and retrieval of textual information. More particularly the present invention relates to searching and retrieving information of large databases such as the Internet, scientific databases, and patents.

### 2. BACKGROUND

Existing text search methods: there are known two major concepts for searching texts. The first one is to search an unorganized collection of text objects by using keywords. The second alternative is to perform classification of text objects into categories, and search the relevant texts accordingly. The use of key words forces the user to choose various words combinations with logical-Boolean connections (and, or etc.). This often does not represent the exact topic in which the user is interested. The results of such search may reveal incomplete data—some sources may be missing due to incomplete choice of key words, and also irrelevant data may appear in the search result, since the same keywords may appear in irrelevant texts. Classification into categories is a time consuming, human handled process. Updating the information is difficult and there is a lot of ambiguity in defining the categories and classifying the data. From the user side, it is inconvenient, since the user is forced to select the relevant category, within a given list, which suites his topic best. In addition, the number of categories needed depends on the degree of specificity of the categories and is very ill defined.

Natural Language Processing

Prior art patents relating to natural language processing, concentrate on solving problems of: meaning ambiguity, complex sentences, and incorrect sentences, by identifying syntactic and semantic structures within the sentence. These structures are either formal, well recognized grammatical structures, or such that are defined by the authors themselves. The sentences analyzed are always considered as full sentences, including subject, predicate and objects which, in most cases, are the only structures that are being sought for and identified. Verbs are essential parts in these analysis methods, so most patents ignore cases where verbs are absent such as cases of “titles”, which are sequences of words which do not combine into a sentence.

In general, some prior art solutions employ computerized indexing for text classification. These indexing methods are based on a word-by-word analysis utilizing electronic dictionary. Although these methods are based also on grammar rules, they ignore language flexibility, thus the text classification may not accurately reflect the text's full meaning.

Other systems of natural language have been proposed as an alternative for key word searching throughout each and every text in a database, such system further enable to search text databases, by parsing syntactic relationships between words and utilizing neural networks methodologies for syntactical analysis.

It is also known to use semantic relationship knowledge base index for relating between pairs of words according to their meaning. For example, such a knowledge base might relate between the words “fish” and “sea”. Such method is ineffective as it demands large knowledge base and complex data processing.

The prior art as described above, provides text indexing or natural language representation which relates only to the single words meaning and grammar form, but ignores the relation between the words and sentence context and structure.

Several prior art patents deal with text analysis according to various syntactic and semantic methods:

Messerly et al. (U.S. Pat. No. 6,076,051, U.S. Pat. No. 6,161,084) uses semantic representation of text for information retrieval. A primary logical form is first created, in which relations between selected words are defined, and hypernyms are then used to define various equivalents to such forms. The primary form considers identification of the main parts in a complete, verbal sentence namely the subject, the verb and the object in the sentence.

Liddy et al patent (U.S. Pat. No. 5,873,056) concentrates on the task of disambiguation in cases where a single word has several possible meanings. For that purpose, statistical methods and likelihood estimations are used At the end of the process, a subject vector is generated which represents the text. The vector represents the main issues that appear in the text, in a descending order of significance (frequency of occurrence).

Stucky patent (U.S. Pat. No. 5,721,938) organizes texts into two basic elements—Nouness and Verbness, which can combine in four types of word patterns. The verb is the 1^{st} to be detected in this work, which only deals with complete sentence&. The order of the words, as well as special words which serve as triggers, are used to derive the correct category (of the aforementioned four) for word patterns. The author's main goals are solving the problem of a grammatically incorrect sentence, meaning ambiguity, and meaning nuances.

Brash patent (U.S. Pat. No. 5,960.384) identifies in a sentence pictures (mostly nouns) and relations, and differentiate between semantic and syntactic meaning of those categories. The author uses a limited amount of signs to differentiate between two types of relations between pictures (“composed of”, “component of”).

Jensen patent (U.S. Pat. No. 5,146,406) identifies the subject, predicate and object in complex sentences, where often the verb (predicate) arguments are not close to the verb, or arguments may be missing. The author differentiates between syntactic parsing into objects and subjects and semantic parsing into deep object and deep subject

Kucera et al patent (U.S. Pat. No. 4,864,502) assigns each word in a text with a tag, designating its grammatical role in the text in order to identify basic syntactic units in the sentence such as noun phrases and verb phrases, including the exact boundaries of those units. A complex, sophisticated method for identifying and annotating those structures is described.

While existing patents concentrate on texts which take a rather narrative type, and as such are composed of complete and often complicated sentences, it should be noted that for the purpose of retrieval of information, different emphasize should be made. The analysis effort must concentrate on text that reveals rich but strict information, not necessarily full sentences. A common situation for informative texts is the case where the main subject is accompanied by a set of words and word combinations that describe that subject in various ways and through various aspects. A verb may or may not exist in such cases, and the text may or may not make a complete. grammatically correct sentence (most titles are not sentences). The texts would be less complicated, but the context of each word within the sentence would be essential for the accuracy of information retrieval. The exact type of description of the subject by the following (or preceding) words is essential for information retrieval purposes.

Functional description analysis; mostly, a word in a sentence either describes another word, or is described by another word, or both. The description may take many forms, since there are many ways by which a word can describe another word. Words that are not verbs or nouns, but rather prepositions are essential in many cases for determination of the exact way by which one word describes another. The functional description of words by other words, specified by the use of prepositions, is essential for real meaning comprehension. In order to comprehend the practical meaning of the sentence, functional treatment of the single word, relating it to the word that it describes, or to the word that describes it, is needed. The exact type of description, as well as a method to represent nested description (a word that describes a word that describes a word), should also be utilized.

All the above mentioned patents do not deal with the interpretation of the single word with respect to its specific, exact functionality within the sentence.

The present invention provides a unified indexing method and system for representing the complete and exact meaning of a given text or structural data based on the meaning of their basic components and the inner relationship between text or data components.

The present invention, propose a searching mechanism based on said index comprising the steps of: specifying the particular subject by user (the information seeker), analyzing it by a designated software which creates index representation of the subject and comparing said representation to pre-indexed database which is constructed according to the same rules of the designated software.

The user specifies his search topic by typing a full title or a representative sentence or sentences, rather than by typing (in most existing methods) scattered keywords, which are logically and syntactically unconnected Thus, the search of indexed database gives more relevant and focused results than prior methods and systems

### 3. SUMMARY OF THE INVENTION

According to the present invention is suggested a method for indexing given text objects, using text parsing module and words indexing database, said method comprising the steps of: parsing text object into words, assigning each word a first index code according to words meaning, assigning each word a second index code according to each word syntax category, assigning each word third index code according to word syntactical role, rearranging words indices according to hierarchical order based on syntactical relations between the text words, assigning differentiating symbols between adjacent words indices, said symbols representing words relations.

### 3.1 BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein

FIG. 1 is a block diagram of the text search system according to the present invention;

FIG. 2 is a flow chart of the parsing and indexing module according to the present invention;

FIG. 3 is a flow chart of the text indexing wizard operation according to the present invention;

FIG. 4 is a flow chart of the automatic classifying algorithm according to the present invention;

FIG. 5 is a flow chart of the comarison module alternatives according to the present invention;

### 4. DETAILED DESCRIPTION OF THE INVENTION

The present invention suggests a new indexing method for text titles or sentences. This method assigns an index which is composed of a string of mathematical signs to each sentence or title. Such index provides a faithful representation of the sentence\title specific meaning, hence a sentence of an identical meaning can be reconstructed from the same index. The indexing method can be applied to a complete text document, or only to the title or summary of the text document. One useful implementation of this indexing method is to create a database of indexed text documents and provide an efficient and intelligent search tools based on the indexing principles.

For providing such search utilities the designated texts databases are indexed, creating a collection of indices representing the texts titles, abstracts and/or the main concepts More detailed description of this stage will be further explained below.

Once all text contained in the database are indexed, any user may conduct a search by entering the search engine a query in the form of a topic, a sentence or a question, which can be simple or complicated, this query is then converted into a search index.

At the next stage, the search engine searches for full or partial match between the sought search index and the large collection of indices, which represents the designated database (within which the search is performed).

The term “keyword” is replaced by the term “key sentence”. Search is conducted using key sentences (or titles).

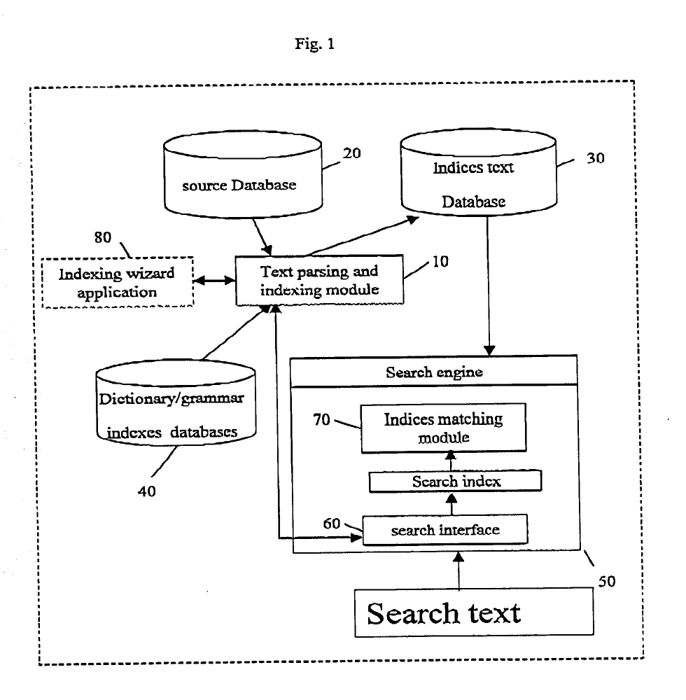

FIG. 1 illustrates a block diagram of a database search system based on the indexing principle of the present invention. The basic component of this system is the text parsing and indexing module 10, which serves for the indexing of new texts of the source database 20 texts and search queries. The indexed texts are stored in text Indices database 30. The indexing module 10 uses indices databases 40 which contains tables of codes: one table of codes symbolizing words meaning, which is based on conventional dictionaries, and grammar code tables symbolizing words syntactical categories and roles.

The search querying process of database 30 is preformed by search engine 50 as follows: the search queries texts of the users are received by search interface 60 and then converted into indexed search texts by the indexing module 10. The comparison module 70 conducts search for matching text documents in database 30 by comparing the search index to the texts indices. Finally, the search results are conveyed to user by the search interface 60.

### 4.1 Representation of Sentences or Titles by an Index

It will be noted that a title of a paper or a book is usually not a sentence (a phrase) in a grammatical sense, but rather it is composed of a main subject and a variety of words that describe it. Sometimes however, titles of papers can be a full, grammatically correct sentence. The proposed method applies for both kinds of titles and for each kind of sentence.

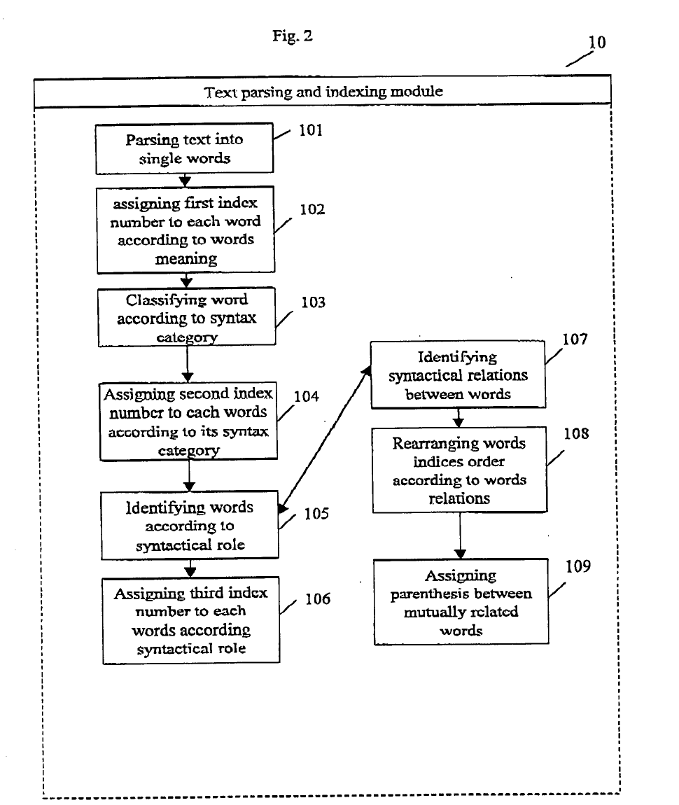

FIG. 2 illustrates a flow process of the parsing and indexing module 10. Generally, for each word of the processed text are assigned three codes according to its meaning and it's syntax properties. The indexing process comprises three phases, the first one relates to indexing of the isolated words, at the second phase the words are indexed in relation to the text context and at the third phase the words indices are rearranged according to a new order which represents the words relation within the text.

Phase I: At the first step (101) of the process the text is parsed into words, for each word is assigned an index, which is comprised of three codes. The two first codes classify the isolated word out of the text contexts: the first code which symbolizes the word meaning (step 102) is constructed by using a full computerized dictionary database. At the next step (103), the word is classified according to its syntactical category (parts of speech) namely: noun, adjective, verb, adverb etc. Based on this classification the respective code to each word is assigned (which optionally is represented by a letter in the index, N for noun, V for verb etc). For example, the word “balcony” is assigned with a first code number 437 according to the index dictionary, and N code symbol according to its syntactical category (“Noun”), thus the isolated word “balcony” is represented by “N437” code in the index.

It should be noted that codes assigned to words that appear in this document are only examples for demonstration, where's the final list is actually a full English dictionary. It should be noted that the 1st two codes are the only ones, which are used in current search engines, namely—the isolated word itself. To summarize, according to the suggested method a serial number will be given to each word, matching an alphabetical order (See appendix A for example)

Phase II: At the second phase of the indexing process, the words are classified according to their syntactical role within the text context (step 105). Based on this classification a third code (the role code) that represents the syntactical role of the word in the sentence (step 106) is assigned according to the basic syntactic rules (subject, predicate, purpose of subject, location of object etc.), with some adjustments. Optionally the index code for the role is positioned before the code letter, which represents the word syntactical category (parts of speech). Using our previous example, if the word “balcony” is the subject of the sentence, after the second phase it will be represented as “1N437” in the index, since for “main subject” role is designated the code number 1 in the role codes table. Overall there are a few dozens different roles. (See appendix B for example)

Phase III: At the third phase of the process the words indices are rearranged according to words relations and differentiating symbols are assigned in-between the related words indices. Optionally parenthesis symbols are used for representing related words, which are syntactically connected. The word preceding the parenthesis is described by the word within the parenthesis.

For example, if the word “white” describes a house, it will appear in the index in parenthesis after the word “house” (house (white)). The words in parenthesis usually describe the word just before the parenthesis. If the subject of the sentence is “white balcony”, it will be represented in the index as: 1N437(7A809), where:

1N437 stands for the subject balcony as described

The following parenthesis usually means that everything within it describes the balcony

“7” is the role index (or code) for the word “white”, meaning: basic description of the balcony, usually assigned to adjectives.

“A” stands for adjective, the part of speech assigned to “white”

“809” is the dictionary (demonstration example) number assigned to the adjective “white”.

It is clear that parenthesis can be assigned to a single word or to a group of words.

As seen in step 107 the words syntactical relations are identified, based on these relations, the words indices are rearranged according to hierarchical relations order (step 108).

Usually the main subject word will be outside the parenthesis, the first describing word will be inside the first parenthesis and the second describing word (which relates to the first describing word) is positioned at the end within a second (nested) parenthesis. For example, in the combination “treatment of addictive adolescence”, the parenthesis is registered as follows:

“treatment (adolescence (addictive))”, since “adolescence” describes

“treatment” (treatment of what?) and “addictive” describes

“adolescence” (what kind of adolescence?) (see detailed example in appendix C)

Synonyms: The method further suggests that synonyms will also be used in an “or” logic whenever a word is sought. For example, if the word “plant” is included in the search sequence index, it will be replaceable with the word “flora”. Existence of the word “flora” in the index representing a text within the database, with all other index parts matching The search sequence will result in a positive answer for that text segment.

### 4.2 The Processes and Techniques Used to Construct the Representative Index

The indexing process as described above can be performed automatically by computerized algorithm, or alternatively with human intervention using software wizard for supporting users manual indexing process.

### 4.21 Constructing The Index Automatically

The Index Construction Algorithm (ICA) analyzes all sentences and titles in the relevant textual section, and assigns an index to each sentence/title. The index will be constructed according to the principles described above. The main tasks of the ICA are to determine the syntactical role code and words relations for rearranging the indices order and setting the parenthesis symbols accordingly. The first two components of the index, namely the syntactical (parts of speech) category code and the word meaning code can be derived simply and directly from a computerized dictionary.

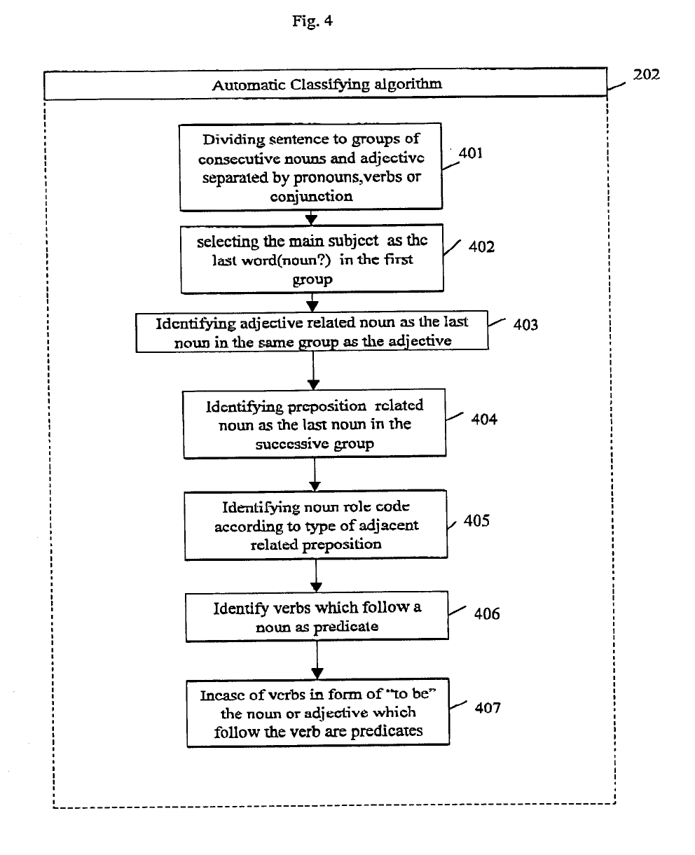

The ICA is based on basic grammatical rules. The ICA algorithm may be further improved adding grammar or statistical rules. An example implementation of these basic grammar rules can be seen in FIG. 4:

As described above (as seen in FIG. 2, step 102), all the words are classified according to their syntactical categories: verb, adverb, noun, conjunction, preposition pronoun, adjective etc.

AT the next stage (step 401), the words in the sentence are divided into groups, or sequences. Each group contains only nouns and adjectives that appear consecutively in the sentence, according to their order of appearance. The groups there separated by pronouns, verbs or conjunctions. The original order of appearance in the sentence is maintained within the group and between groups.

The syntactical role of each word and its relation to other text words is determined according to its relative position within each group and its relative position to other words. For better understanding of these principles, the following preliminary set of rules is suggested.

The main subject in a sentence (step 402) is determined according to the last word in the initial (first) sequence (or group) of words in the sentence that contains only nouns and adjectives.

Some words, such as: “the”, “very”, “and” are ignored since they do not affect the index.

Adjective role is determined (step 403) according to the last noun in the same group. Adjective, in most cases, is assigned role number 7 (simple adjective) in the role list (appendix B)

Conjunctions, prepositions (step 404): In contrast to other search engines where prepositions are omitted, here prepositions and some conjunctions (such as “because”) are essential for constructing the index. In the basic form of the ICA, a preposition refers to the last noun in the following group.

For determining the syntactical role of the respective noun (In relation to its proposition) (step 405) are suggested two alternative rules;

First rule: Literally, according to the proposition meaning, e.g.: a noun following the preposition “in” answers the question: “in what?”.

Second rule—using intelligent generalizaton: A noun located after “in” answers in most cases, the question “where”, and serves as a description of location (which is role number 4 in the role list in appendix A)

It should be noted however, that while the algorithmic implementation of the first method is straightforward, the second method, although more efficient, is more difficult and should consider various possibilities for a specific preposition, where each possibility produces different index for the role. “in” for example can be followed by a noun that refers to time (“in a minute” “in a while”) and in that case this noun will not describe location so it will not be designated as role number 4.

Verbs: The presence of a verb usually makes a sentence, in contrast to a title, in which verbs are often missing. A verb which follows the main subject is usually the predicate (role number 100 according to appendix A), unless the verb is in the forms of the verb “to be” where's in this case the adjective or tie noun which follow verb are the predicate (the verb conjugate of “to be”, in contrast to all other verbs, refers to the case where the subject “is something” in contrast to the case where the subject “does something”, respectively).

The automatic indexing process can be used solely as a computerized automated processes or as a pares of an integrated semi-automatic process, which involves human intervention.

When conducting a smart search, based on the indexing technique described above, without any cooperation from either the text creator or the information seekers, the ICA constructs the index automatically, including more than one index alternative (due to uncertainties as to which is the correct index). Tie alterative indices, are joint by using logic operators such as “or”. The matching algorithm, which determines the degree of match between the textual database and the search query will check all the alternatives indices according to the logic operator. In other words, if there are few possibilities for the index representing a text then all will be taken into account.

### 4.2.2 Constructing the Index with Human Intervention

Although human intervention complicates the indexing process, its results are more precise and provide more efficient search process. The search process has two ends: The person (or persons) who creates the information and the one looking for it. In some cases the users who create the text information are the same one which search the databases. It is more than likely that a user will have the motivation to make an effort for improving the indexing process. The creator of the information can be for example, the author of a scientific paper or a company that makes home pages in the web. The information seeker can be a student writing his thesis or someone who “surfs” in the Internet. Two assumptions are made about these two ends: A. The people involved are likely to be educated and intelligent. B. They are willing to spend time and effort in order to produce the best search results: The information creators want that everyone interested in their work will have access to it, and the information seekers want to find all the relevant information, and only the relevant information.

Thus, the integration of human intervention in the indexing process of both the original text and the search query can be considered a practical, possible approach.

The user which composed, or edited any textual segment (a paper, a patent, etc.) is advised to summarize the essence of the text in one or few sentences or concepts. The summaries may contain a title and the abstract, which represent the whole textual segment for the search engine. For indexing these summaries the author shall use ad indexing application as will be further described bellow.

The user who seeks information in the textual databases will type his/her search query in the form of title/s, concept/s or sentence/s, and use the same wizard for conducting the indexing process.

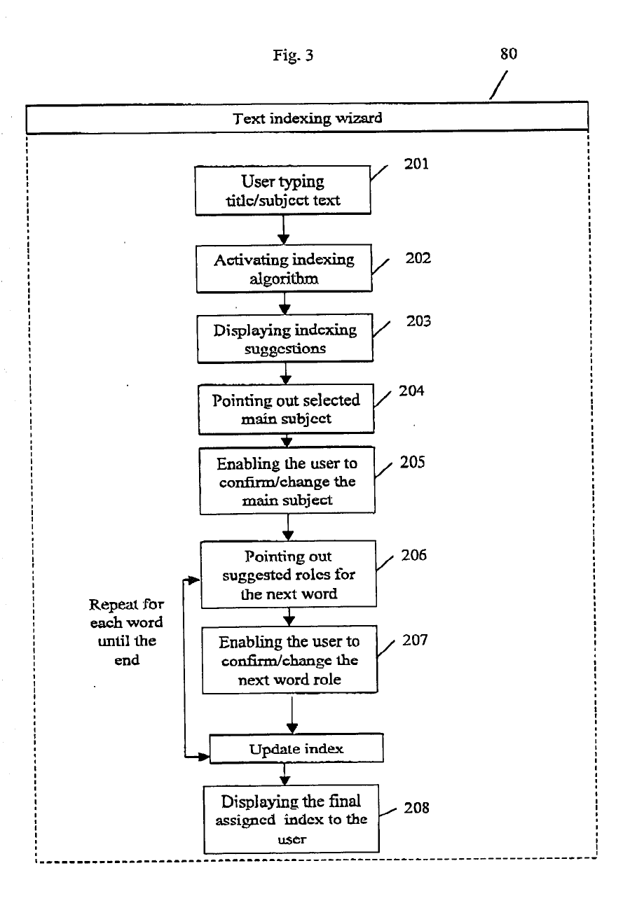

FIG. 3 illustrates the basic stages of the wizard application operation.

The wizard operation enables to gradually construct the index through the interactive dialog with the user. Such operation is accomplished according to the following stages:

The wizard receives the text to be analyzed (step 201), for example: a given search topic “Treatment of addictive adolescent with art therapy”

The wizard application activates the automatic indexing algorithm ICA (as described above) to analyze the text As a result, the algorithm produces an initial guess for the index, including alternatives in case of indefinite decisions.

The wizard application presents the user with a couple of alternative index suggestions (step 203) enabling the user to confirm/select one of the suggestions. At the first stage the wizard application points out (step 204), on the screen, a word from the given title, which was selected by the algorithm as the main subject of the user's topic. (in the role index coding described in appendix B, the role “main subject” in the sentence is assigned role code 1). If the algorithm suggestion of the main subject seems unsuitable to the user, the user can select any of the other words (step 205), which he presumes to be the “real” main subject of the title. Referring to the example—the term “main subject” appears with a pointer to the suggested word: Treatment

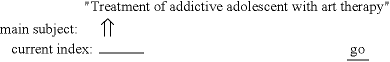

For speeding up the process, the user will point out the true “main subject” of his topic, only if it is different from the one that appears on the display (the ICA 1^{st} choice). If the algorithm first best choice is correct, the user just types “go”. The first constituent of the index will immediately appear on the screen namely: 1N25 (1-for “main subject” role, N for Noun, 25 for treatment which is noun number 25 in the dictionary). The dialog continues to the next stage.

In the next stage (steps 206, 207), the words which are related to the main subject an their syntactical role are determined. The dialog process is similar to the first one (for selecting the main subject), the algorithm provides its suggestions and the user can confirm the first one or select from the other available options. Referring to the example: The word Adolescent will be the next to be pointed out, with some alternatives for its role as a word describing the main subject:

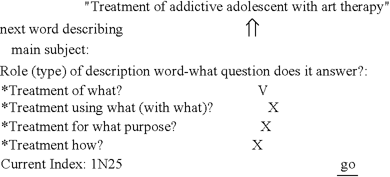

As shown above, the role of the word “adolescent” is presented to the user in terms of a question about the main subject, for which the descriptive word (“adolescents”) is the respective answer. This is done for simplicity and clarification for those not skilled with grammatical terms. In this case, the user confirms the algorithm first choice (Treatment of what) by pressing “go”.

The next symbol is now added to the index which becomes 1N25(8N26) meaning: Noun number 26 in the dictionary is “adolescents”, it describes the main subject “treatment” and its role number is 8 in the role list—it answers “of what?” (appendix B). The wizard application continues to the next stage.

The dialog process continues in a similar manner: The algorithm points out a descriptive word, the suggestions about its role are presented in a descending order of confidence, the user confirms the first suggested role by typing “go” or selects another choice from the list.

Symbols are added accordingly to the index, until completion. The complete presentation of the example, appears at appendix C.

Proposed Linkage Between the Two Approaches:

The computerized dialog with the user in section 4.22 and the ICA described in section 4.2.1 complement one another in the following manner:

A preliminary version of the ICA shall be written according to the principles described in section 4.2.1

This version will be used for the “first guess” of the index, presented to the user according to the stages described in section 4.2.2. The index parts will be reveled to the user gradually in the structured manner described.

Alternatives for the various index parts, evaluated with a lesser confidence by the ICA, will be presented in the form of multiple choices as specified in section 4.2.2. The best choice will be presented at the top of the list, and the alternatives down below.

The user can type “go” if he approves the ICA 1st choice, or he can choose any of the optional choices presented to him below (and then type “go”)

As the ICA will be constantly upgraded and improved, the initial, 1st guess will be correct in increasing portions. Upon completion of the ICA (estimated two years from beginning of development), the initial index will be correct in over 95% of the cases. Only in very few occasions will the user have to correct the index, and the dialog will be displayed only upon special user request and not every time.

### 4.3 The Matching Algorithm (MA) and Graded Matches

As explained, the MA determines if an index representing a search query matches an index representing a text within a database. The MA does not perform a “blind” match, in the sense that it does not approve only perfect match. The algorithm may have varying operations mode, each mode providing different results according pre-defined degree complexity (of search scope, filtering and desired search accuracy).

### 4.3.1 Grading

There will be various degrees of matching, and different criteria associated for each degree. The main criteria types will be as follows (in an ascending order of matching grade):

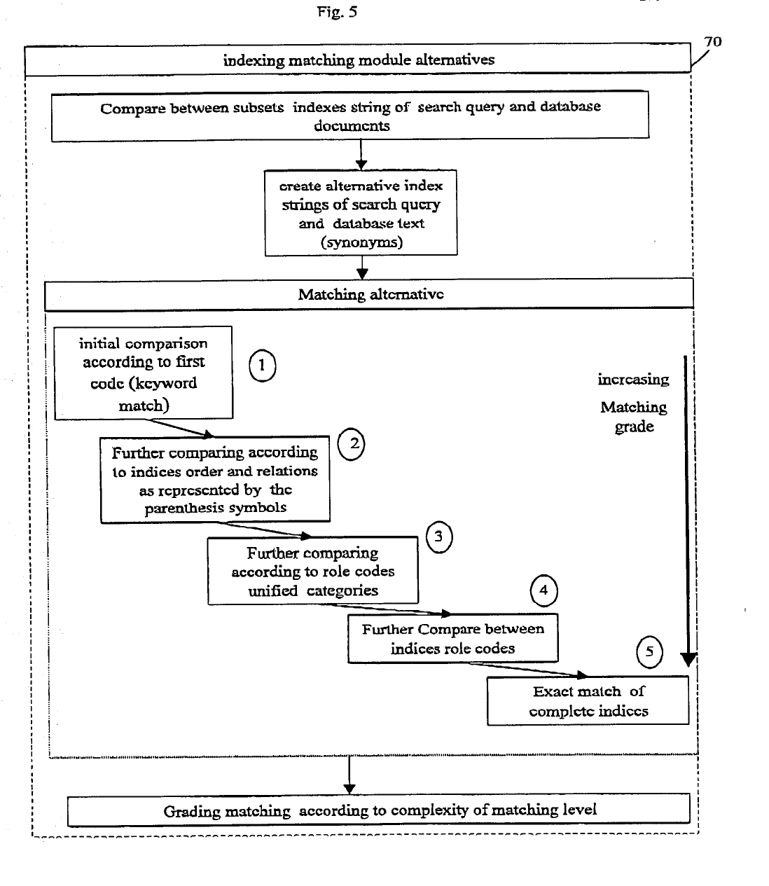

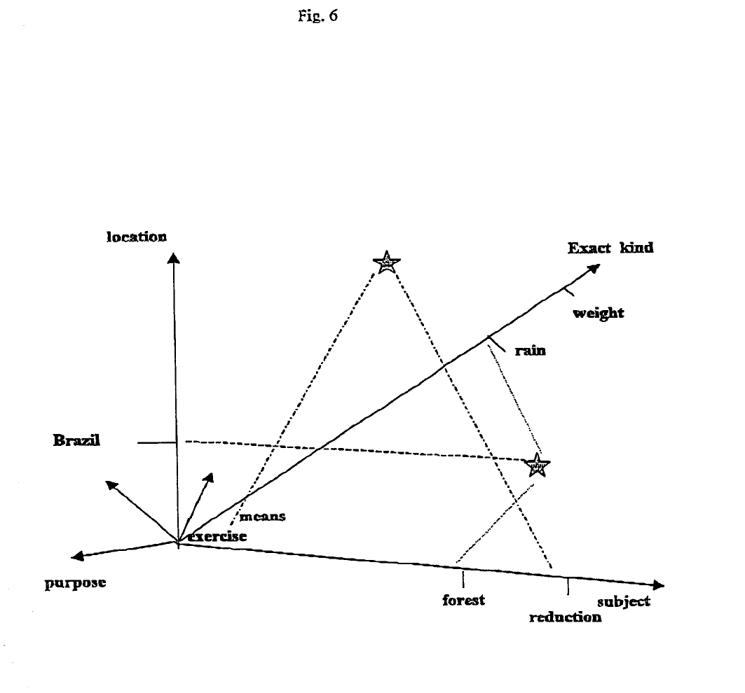

FIG. 5 illustrates five alternatives of the matching processes:

The first option, which provides the broadest search scope, is by matching key words as in conventional search engines, ignoring prepositions and conjunctions (no indexing). The key words can be located all in one sentence or title, or scattered within the whole text. The matching approximation is affected by proximity level (number of words/sentences separating between any two key words). The proximity level will affect the grading.

According to the second option (FIG. 5), the MA compares between the indices, not including syntactical role code of the index: Only the first two codes indices and the parenthesis are considered for the match. This approach considers which word relates to which, without considering the exact type of relations.

For Example, “rescue of animals” and “rescue by animals” will be considered as matching under this approach, since in both cases the word “animals” describes “rescue” (although in two different ways) and will be registered in parenthesis after “rescue” in the index representation.

According to the third matching alternative in FIG. 5, the search scope is expanded by grouping various roles from the roles list together, forming more general category of roles. (Such category includes several roles). For the MA, roles of the same category will be considered as a match. Example: roles number 2 (what kind exactly) and number 8 (of what?) can be grouped together.

In the fourth matching alternative, the search engine may consider a match between full indices wherein only part (a subset string) of those indices is equivalent. In fact, in most cases—only partial matching is expected, since the source text, which the index represents, is usually longer and more detailed then the query. (See option 4 in FIG. 4) (In general, some propositions will be considered equivalent, subject to their specific context in the sentence.)

In the fifth alternative the search engine matches the search string itself for complete match. This logic results in a high grade for the match but it is rarely found, and the chances to miss relevant data are high, especially for long strings (indices).

In Cases of ambiguity, when one word has more than one meaning, logic operator “or” is used for the matching process. If two different indices have the same or similar meaning, they are considered as a match. Alternatively, a title/sentence can be represented by more than one index, each index representing a slightly different alternative variation of the same textual meaning.

Example 1: “Methods for image processing”, “methods of image processing” and “Image processing methods” are associated with slightly different indices, with the difference concerns the role of “image processing” in the title. However, these two indices will be treated as matching one another

Example 2: Sometimes the subject and its main descriptive word are interchangeable, living the concept almost the same. In “abuse of children” and “abused children” the subject has “switched” from “abuse” to “children”, but the main concept or title are basically the same. In this case too, the two indices will be considered a match.

Synonyms options are processed by using an “or” logic, as described previously. For example, “methods” and “techniques” are equivalent indices for the matching algorithm.

An example of the comparison process is described in Appendix D.

### 4.4 Other Applications Implementing the Present Invention Method

The indexing process of textual information as described above can be used for development of new methods in two different areas:

A. Improving human interaction with computer processing

B. Better organization of human knowledge

These two issues are specified bellow.

4.4.1 Human interaction with the computer: The indexing technique can be referred to as a new language used for better communication between man and computer: The computer is “taught” to understand the human language as is, without the need for computer-dedicated commands (as is the case in conventional software language such as Fortran, C++, etc). The user has to compromise in the sense that he should use formal and strictly informative texts: The nuances of the language are not well expressed with the indexing method, at list for current stage of development.

### 4.4.1.1 Commands to Computerized Systems (Robots, Computers):

Since the indexing technique relates to the meaning of the sentence and not just to keywords, it can be used to give commands to computer system, as demonstrated in the following examples:

Command: Pick Up the book and put it on the table

Index:200V6(13N42),200V7(13N42,4N43)

Command: Fix the Spaceship and Drive to the Moon

Index: 200V8(13N44),200V9(4N45)

Where's role number “200” preceding a verb designates the imperative (command) form of the verb, see appendix B.

The computer must be provided with a dictionary including the meaning of the words. The indexing method enables the computer to identify the correct relations between the words and place each word in its true context.

### 4.4.1.1 Asking the Computer Questions

With a slight modification, the index can represent a question referred to the computer, and the MA can be used to search for an answer to that question, by matching appropriate sequences in the question and the textual database. An example is demonstrated:

Question: How is African Art Differs from Previous European Art?

### Question Index: 1N29(2A11),100V5(11N29(2A12,2A13)),9Q?

Question index details: In the question index, the symbol “Q” designates a question. It is preceded by the role about which information is required and asked for. Role number 9 (Means “in what way?” according to the role list, see appendix B) precedes the “Q” symbol, so the question concerns role number 9. The person asking the question does not know this role, so he wants an answer that will refer to this role, an answer to the question: “in what way . . . ?”

### Answer Index:

### 1N29(2A11),100V5(11N29(2A12,2A13),9N34(2A14,8N35(8N36,8N 3)))

Matching Sequence is Underlined

Answer: “African Art Differs from Previous European Art in its Ruthless Distortion of the Human or Animal Form” (from “40000 years of modem art”)

Answer index details: The matching index would be similar to the question index, and will include the role about which the question is asked. In the example—the MA looks for an index (from the textual database) with the same main subject (African art) and predicate (differs), in which role number 9 appears and specified.

### 4.4.2 Contents Screening

Content Screening is needed today, mainly for emails and Web surfing. A common example might be the protection of children and youngsters from sex related content, which is not supervised and anti-educational. Using keywords for screening is not an optimized solution since same keywords might appear in both undesired and desired texts. Sex issues can be discussed for example, within researches and in statistical surveys and used for e-learning.

It is assumed that screening using key sentences will be more efficient, provided that the sentences screening will be more carefully performed. The screening process will consider the meaning and intentions of the text providers, so the rejection or exception of texts will not go blindly by the presence or absence of predetermined words.

### 4.4.3 Automatic Classification Into Categories

This task is considered highly important for document handling, search engines based on search by categories, and many other applications. Automatic classification should highly improve using the index codes method by the concept of key sentences. Keywords based classification is highly ambiguous since the same word may appear in texts related to more than one category. With key sentences however, as are used in the present invention, this may rarely happen, if any.

### 4.4.4 Summarization of Texts

The indexing method can be used to summarize lectures, books, papers and other text types so the information is highly accessible for any user, through the intelligent search method proposed. It can become a main channel for storing textual information in computerized databases.

### 4.4.5 Better Organization of Knowledge

4.4.5.1 Application of Method for Tables

The indexing method can be applied for indexing tables in a similar logic. The columns and the rows of the tables will be represented by the roles and the titles of the rows/columns will be treated as words in a regular sentence. For example, the table:

| Vehicle | | | |
|---|---|---|---|
| Attribute (typical) | Bicycles | Motorcycle | Cars |
| Price | 200$ | 2000$ | 20000$ |
| Speed | 20 km/h | 80 km/h | 120 km/h |

Can be represented in the database by the following index:

T, 1(N30(7A10N31, N32))),2(N33(N34,N35,N36)) (The words are not included in the dictionary in appendix A)

Legend:

“T”—A common letter initiating any table index (T for table)

“1”: The role number for rows

“2”: The role number for columns

“N30(7A10)”; Noun number 30 (attribute) is the main category for all the rows titles, Adjective number 10 (typical) describes it simply according to role 7 in appendix B.

“N33”; Noun number 33 (vehicle) is the main category for all the columns titles

“(N31,N32)”: rows titles are nouns 31 (price) and 32 (speed)

“(N34,N35, N36)”: Columns titles are nouns 34 (bicycles), 35 (motorcycle) and 36 (cars).

### 4.4.5.2 Application of Method for Specific Fields: Biological Pathways

As explained, any sentence or title can be represented faithfully by the proposed index. It is possible however, to “ZOOM IN” with an extra-detailed index for various applications and fields of interest such as finance, entertainment, music etc. An example for such extra-specific indexing will be described here.

Prior art searching and database mining of the DNA RNA and Proteins are mostly done by sequence and gene database. According to the present inevntion is proposed a search engine based on the “sentences” which describes the results of test Utlizing the indexing and searching utlities as descibed above for analayzing bilogic reaction results enbale to make a logic and order into this tremendous amount of exsiting literature in this subject.

This example concerns cell biology, and refers to the family of processes called “Biological Pathways” (BP). BP are important in understanding the Human Genome and its impact on diseases and human attributes. Various companies currently seek for a standard format that can describe BP in a simple, comprehensive and easy to use manner. Retrieval of information concerning BP will be made easy with a suitable format, as well as comparing research results, detecting contradicting evidence, and integrating information from various BP towards a generalized theory of human physiology, behavior and pathology.

In general, BP is a sequence of chemical reactions in which one compound reacts with another to form a 3rd compound, which in turn participates in the formation of a 4th compound, and so forth. Enzymes can take part in the reactions. The BP can be a cyclic process in which the end products and the initial products are the same compounds. The example below follows the structure of the BP called: “The Citric Cycle”

There are three categories relevant to BP:

A The compounds involved in the process- designated by the letter “M” followed by a number representing a specific compound. The number registered to each compound should match a dictionary of chemical compounds, in a similar manner to the dictionary specified in appendix A.

There are three ways by which a compound takes part in the BP:

The main (central) role, designated by MC, in which the compound is one of the links in lie chain of reactions: the main product of a reaction.

As an additional Input Substance, designated by MI, taken from the surrounding materials as a part of the reaction.

As an additional Output Substance, designated by MO, which is a by product of the reaction (compared to the main product which is MC)

Schematically this can be represented by the following formula:

MC#+MI#−>MC#+MO#

Where's “#” represents any compound number from the chemical dictionary.

Compound examples are: Malate, Fumerate or Acetyl-CoA.

B. The type of reaction involved: in BP terminology each reaction type has a specific name, such as Hydration, Dehydration, Condensation etc. The reaction is designated by the letter “R”, followed by a number related to each reaction according to a dictionary of reactions.

C. The Enzyme involved in the reaction is designated by the letter “E”, followed by the number related to each enzyme according to a dictionary of Enzymes. Some Enzymes examples: Fumarase, Aconitase, Citrate Synthase etc.

The BP would be cyclic if the end product and the initial material are the same compounds.

For demonstration, we start with short dictionaries for the compounds, the reactions and the Enzymes involved in the Condensations and Dehydration initial stages of the Citric Acid Cycle:

Compounds dictionary: 1-Oxaloacetate/2-Acetyl_CoA//3-Citrate//4-H₂O//5-CoA-SH//6-cis-Aconitate

Reactions dictionary: 1-Condensation/12-Dehydration

Enzymes dictionary: 1-Citrate Synthase//2-Aconitaze

The index for the two reactions above will be as follows:

MC1(R1MI2E1MI4MO5)MC3(R2E2MO4)MC6

Designating the following:

Oxaloacetate (MC1) condenses (R1) with Acetyl-CoA (MI2) to form Citrate (MC3). The condensation is catalyzed by the enzyme Citarte Synthase (E1), and is accompanied by the intake of water (14) and the liberation of Co-A-SH (MO5). In the following reaction, Citrate (MC3) dehydrates (P2) to form cis-Aconitate (MC6). The dehydration is catalyzed by the Enzyme aconitase (E2), and is accompanied by the liberation of water (MO4)

### 4.4.5 A New Approach to Knowledge Organization

The indexing technique can be used to represent each fact, or concept, or title as a single point in multi dimensional space system. The dimensions in his system will be the roles. Along each role axis, all the words will be registered in a consecutive manner. An example is shown in FIG. 6.

The subjects represented in the figure above are: “Rain Forest In Brazil” and “weight reduction by exercise”

It is not yet determined how the words within a specific dimension (along any axis) should be arranged. The answering probably relates to the use of different sorting criteria according to a specific application, or usage. For exact sciences, for example, tangible nouns can be coarsely sorted according to size, and a finer sorting can be done according to chemical composition.

This mathematical-graphical representation of knowledge can be used to identify contradictions, knowledge gaps, and new subjects that should be investigated. It is assumed that algorithms that will be based on this representation will increase the efficiency of usage of existing knowledge to a higher degree than today.

While the above description contains many specifications, they should not be construed as limitations within the scope of the invention, but rather as exemplifications of the preferred embodiments. Those that are skilled in the art could envision other possible variations. Accordingly, the scope of the invention should be determined not only by the embodiment illustrated but also by the appended claims and their legal equivalents.

[image]

[image]

[image]

[image]

[image]

[image]

What is claimed is:

1. A method for indexing a given text objects, using text parsing module and words indexing database, said method comprising the steps of:
A. parsing text object into words;
B. assigning each word a first index code according to words meaning;
C. assigning each word a second index code according to each word syntax category;
D. assigning each word third index code according to word syntactical role;
E. rearranging words indices according to hierarchical order based on syntactical relations between the text words;
F. assigning differentiating symbols between adjacent words indices, said symbols representing the words hierarchical relations;

2. The method of claim 3 wherein the differentiating symbols are parenthesis;

3. The method of claim 1 wherein words syntactical role and words relations are identified by utilizing computerized process, said process comprising the steps of:
A. dividing the given text object into subsets of consecutive nouns and adjective wherein said subsets are separated by pronouns, verbs or conjunctions.
B. classifying the words syntactical role based on their syntactical category according to their respective location within the text subsets or relative position to other words;
C. identifying the words relations based on their syntactical category according to their relative position to other words;

4. The method of claim 3 where the process of identifying words syntactical role and words relations is further supported by human intervention, said process further comprising the step of:
A. Providing a user with alternative suggestions of syntactic roles and word relations, presented according to descending preference order;
B. Enabling a user to confirm the first suggestion or select one of the other suggestions;

5. The method of claim 3 wherein the classification of nouns role is based on the type and meaning of the respective preposition in the text.

6. The method of claim 3 wherein the verbs appearing after a noun are classified as predicates.

7. The method of claim 3 wherein the last noun in the first subset is classified as the main subject;

8. The method of claim 3 wherein the adjectives nouns relations are identified when appearing in the same subset in sucessive order;

9. A searching method for receiving relevant text objects out of collection of text objects according to text query wherein the text objects and the query text are indexed according a first code identifying words meaning, a second code identifying word syntactical category, said method comprising the steps of:
A. comparing the query text index to each text object index;
B. identifying partial of full match between text objects query index and the text object index;
C. selecting the most relevant text objects wherein the relevance is determined according to identified index matching;

10. The method of claim 9 wherein the query text and object text indices are rearanged according to an hirarchical order based on identified word relations and differentiating symbols which represent the indices hierarchical order are assigned between adjacent words indices.

11. The method of claim 9 wherein the query text and object text indices further include third index code identifying word sytactical role in relation to other text words

12. The method of claim 9 wherein the third index codes are grouped according to defined categories of sytactical roles.

13. The method of claim 9 wherein the the comparison operation further comprise the step of comparing the first code index to different indices which represent the respective word synonyms.

14. A method for indexing a given information table, using text parsing module and words indexing database, said method comprising the steps of:
A. assigning each row and column titles a first index code according to words meaning;
B. assigning each row and column titles a second index code according to each word syntax category;
C. assigning each row and column title a third index code representing table location(column title or row title);
D. arranging titles indices according to hierarchical order based on their position within the table;
E. assigning differentiating symbols between adjacent titles indices, said symbols symbolizing the words hierarchical relations;

15. A method for indexing a given sequence of chemical reactions, using indexing module and biological indexing databases, said method comprising the steps of:
A. assigning each chemical compound of the reaction a first index code representing its name;
B. assigning each chemical compound of the reaction a second index code according to each compound role (main product, input substance, output substance;
C. assigning each reaction a third index code representing the type of reaction;
D. assigning each reaction a fourth index code representing the type of enzyme which participates in the reaction;
E. Arranging reaction indices according to hierarchical order representing the reaction process sequence;
F. assigning differentiating symbols between adjacent indices, said symbols symbolizing the reaction process interaction;

16. A system for creating indexed text database objects, said system comprised of:
A. words/grammar indexing databases, wherein the indexing databases comprise a first code identifying words meaning, a second code identifying word syntactical category and a third code identifying syntactical role.
B. A text parsing and indexing application for identifying words syntactical category and role.
C. Analyzing module for identifying syntactical relations between text words, rearranging the words index in hierarchical order according to identified relations) and assigning differentiating symbols between adjacent words indices, said symbols representing the words hierarchical relations;

17. The system of claim 16 wherein the indexing module is comprised of:
A. parsing module for dividing the given text object into subsets of consecutive nouns and adjective wherein said subsets are separated by pronouns, verbs or conjunctions.
B. Classification module the identifying words syntactical role based on their syntactical category according to their respective location within the text subsets or relative position to other words;
C. Analyzing module for identifying the words relations based on their syntactical category according to their relative position to other words;

18. The system of claim 17 further comprising a wizard application for supporting human intervention in the process of identifying words syntactical role and words relations, said wizard enabling users to select out of alternative suggestions of syntactic roles and word relations which are presented according to descending preference order;

19. The system of claim 17 wherein the classification of nouns role is based on the type and meaning of the respective preposition in the text.

20. The system of claim 17 wherein the verbs appearing after a noun are classified as predicates.

21. The system of claim 17 wherein the last noun in the first subset is classified as the main subject;

22. The system of claim 17 wherein the adjectives noun are identified as related to a noun when appearing in the same subset in sucssesive order;

23. A searching system for receiving relevant text objects out of collection of text objects according to text query wherein the text objects and the query text are indexed according a first code identifying words meaning, a second code identifying word syntactical category, said method comprising the steps of:
A. Matching module for comparing the query text index to each text object index and identifying partial of full match between text objects query index and the text object index;
B. Selection module for retrieving the most relevant text objects wherein the relevance is determined according to identified index matching;

24. The system of claim 23 wherein the query text and object text indices are rearanged according to hirarchical order based on identified word relations and differentiating symbols which represent the indices hierarchical order are assigned between adjacent words indices.

25. The system of claim 23 wherein the query text and object text indices further include a third index code identifying word sytactical role in relation to other text words.

26. The system of claim 25 wherein the third index codes are grouped according to defined categories of syntactical roles.

27. The system of claim 23 wherein the the comparison operation further comprise the step of comparing the first code index to different indices which represent the repective word synonims.
